(19) United States
(12) Patent Application Publication
(10) Pub. No.: US 2015/0345750 A1
(43) Pub. Date: Dec. 3, 2015

(54) Lighting Systems

(71) Applicant: Ralph James Tyler Oakley, Whitby (CA)

(72) Inventor: Ralph James Tyler Oakley, Whitby (CA)

(21) Appl. No.: 14/729,707

(22) Filed: Jun. 3, 2015

Related U.S. Application Data
(60) Provisional application No. 62/007,143, filed on Jun. 3, 2014.

(51) Int. Cl. F21V 14/02; B66F 7/28; F21S 8/08

(52) U.S. Cl. CPC F21V 14/02; F21S 8/08; B66F 7/28; F21W 2131/403

(57) ABSTRACT

Disclosed is a lighting system including a hoist having one or more posts in a substantially vertical orientation, two or more arms in a substantially horizontal orientation, each attached to one of the posts, and each having an upper surface for receiving a vehicle. Lighting units are provided, each attached to the hoist apparatus. Each of the units provides light at an intensity and illuminates an underside area of the vehicle when it is operatively positioned. Each of the lighting units is adjustably disposed at an angle from the apparatus. Also provided is a control unit for setting and/or responsively altering one or more of the angle and intensity of one or more of the lighting units, based on one or more of direct input from a user, monitored data, and one or more parameters pre-selected from a set of parameters.

### Cross Reference to Related Applications:

This application claims priority to U.S. Provisional Patent Application No. 62/007,143, filed on Jun. 3, 2014, the contents of which are hereby incorporated by reference in their entirety.

### FIELD

This disclosure relates to lighting systems for use with vehicle hoists/lifts.

### BACKGROUND

When performing vehicle maintenance or repairs (which includes, for example and without limitation, automobiles, trucks, buses, heavy equipment and the like), it is often necessary to lift the vehicle off the ground or otherwise gain access to its underside (for example, using an in-ground system of access). Above ground access is typically accomplished using apparatuses known in the art as hoists. These devices typically include a plurality of arms, which may be referred to in the art as “posts”. Hoists having two or four posts, which are typically hydraulically or pneumatically powered, and may be presented in levered arrangements, are often used to lift vehicles and facilitate access to their undersides.

Most buildings, repair and service centres are generally lit from the ceiling or, at least, from a position without a line of sight to the area of interest height on the hoisted vehicle. Even in cases where the most up to date lighting systems are provided in such environments, the positioning of the vehicle in either the above ground or in-ground systems generally described above is such that it blocks the light from reaching the point(s) of interest to service personnel. As such, it is necessary to provide additional, localized and directed sources of lighting to allow service personnel to see what they are doing under the vehicle. In many cases, highly directed light is required in order to allow clear viewing of the sometimes intricate vehicle part(s) being worked with.

Conventional solutions to this problem have included movable lights, often referred to in the art as “trouble” lights. These lights may be attached to or about the vehicle, for example by way of a hook or magnetic means of attachment, or may be held by the service position so as to be positioned to provide lighting for the point(s) of interest. Problems associated with the use of such means of lighting include that they do not provide sufficient light to illuminate the point of interest, they are cumbersome and subject to dropping and breakage, and that they may be inadvertently left attached to the vehicle upon completion of the maintenance/repair task(s). Any such devices that require internal power sources also suffer from the problem that related cords create a tripping hazard to service personnel.

In some instances, service personnel will supplement the light provided with trouble lights by using a flashlight in their hands and/or mouths. This is problematic in that it lessens the ability of the service personnel to focus on the task(s) at hand and, in the case of lights held in mouths, does not provide the ease of use and control (e.g., of the direction and/or intensity of the light) that are desirable when engaged in complex and detailed sets of tasks. Further, smaller lights typically illuminate a smaller area and necessitate additional movement by the service personnel (e.g., through hand or head movement) which may also distract the personnel from the task at hand and/or alter postures so as to potentially increase risks of workplace injuries.

As such, it is necessary to provide lighting solutions that alleviate or eliminate one or more of the aforementioned problems

### SUMMARY

There is disclosed herein a lighting system comprising a hoist apparatus comprising one or more posts provided in a substantially vertical orientation; two or more arms provided in a substantially horizontal orientation, each attached to one of the posts at a first end thereof, and each having an upper surface configured to receive a vehicle; one or more lighting units each attached to the hoist apparatus; wherein each of the lighting units is adapted to provide light at an intensity and is configured to illuminate an underside area of the vehicle when the vehicle is operatively positioned; wherein each of the lighting units is adjustably disposed at an angle from the apparatus; and, a control unit for setting and/or responsively altering one or more of the angle and intensity of one or more of the lighting units, based on one or more of direct input from a user, monitored data, and one or more parameters pre-selected from a set of parameters.

In another disclosed aspect, the lighting units are provided integral to and substantially flush with an inner surface of each of the arms.

In another disclosed aspect, the direct input comprises selection of a repair routine comprising details of a vehicle the user will be servicing, and the nature of the servicing.

In another disclosed aspect, wherein the set of parameters comprises a plurality of lighting arrangements, wherein in each of the arrangements one or more areas of the underside of a vehicle would be illuminated and the intensity of each of the lighting units would be set accordingly.

In another disclosed aspect, the monitored data comprises one or more of: a position of the user; an orientation of the user; and, a position of the vehicle.

In another disclosed aspect, the hoist apparatus further comprises a floor, and the post further comprises a second end distal to the first end and affixed to the floor, and at least one of the lighting units is attached to the floor.

In another disclosed aspect, at least one of the lighting units comprises a light emitting diode based light source.

In another disclosed aspect, the intensity comprises a measurement in candelas.

In another disclosed aspect, the intensity further comprises a focus area. In another disclosed aspect, the system also includes a plurality of attachment ports provided on the hoist apparatus, each adapted to receive the lighting units, wherein the lighting units are configured for engagement with and disengagement from the attachment ports

### DRAWINGS

FIG. 1 is a perspective view of a disclosed system.

FIG. 2 is an enlargement of area B, shown in FIG. 1.

FIG. 3 is an enlarged view of a lighting unit.

### DETAILED DESCRIPTION

There is provided a lighting system for use with or as part of hoist apparatuses. In this disclosure, the terms “hoist” and “lift” are used interchangeably to refer to devices for elevating or providing access to the underside of vehicles for the purposes of repairs or inspection. While both terms imply raising the vehicle (e.g., by hydraulic, pneumatic or mechanical means, or via ramps), systems disclosed herein are likewise applicable to use in embodiments wherein the vehicle is substantially at ground level and the service personnel descends into a pit provided for the purposes of access to the underside of the vehicle.

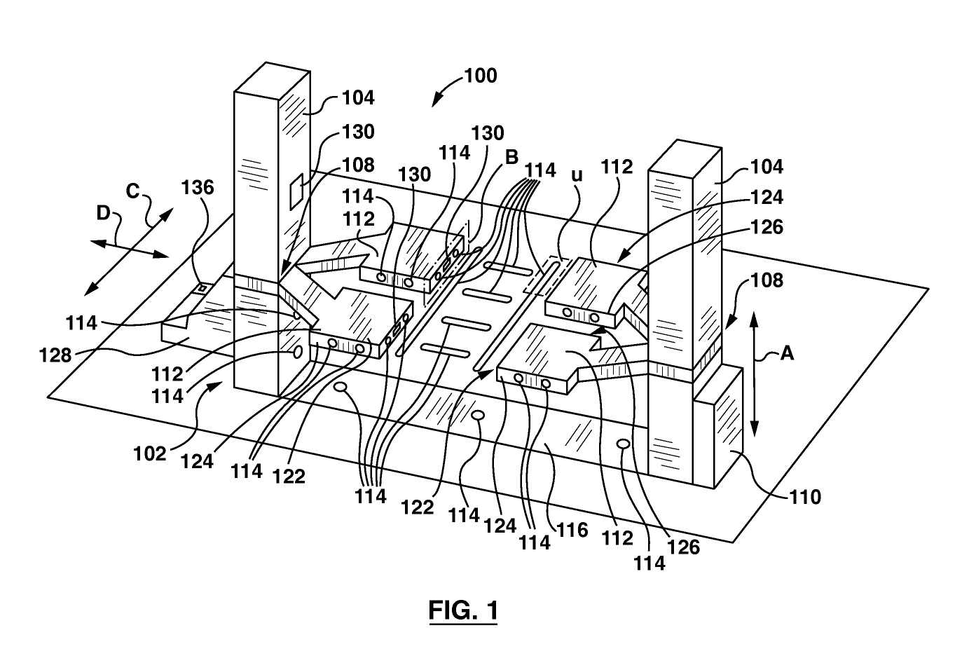

Furthermore, and looking to FIG. 1, in which an embodiment of a disclosed system 100 is illustrated, a post-surface mounted type of lift is shown. However, it will be appreciated that disclosed systems could be provided in the form of various other lifts. For example, multi-post runway lifts, low/mid rise frame engaging lifts, drive-on parallelogram lifts, scissor lifts, moveable-type wheel-engaging lifts, and in-ground lifts. In each instance, design choices would need to be made regarding the placement of aspects of the system; however, these choices would be made on substantially the same bases as would be the case in respect of the embodiment illustrated in FIG. 1.

Turning more specifically to FIG. 1, there is illustrated lighting system 100. A hoist apparatus 102 is provided as part of the system 100 and includes a pair of posts 104, which are provided in a substantially vertical orientation. In other embodiments, more or less posts may be employed, depending on the nature and size of the vehicle (not shown) involved, as well as the choice of type of hoist/lift. A plurality of arms 106 is provided. In FIG. 1, two arms 106 are shown attached to the posts 104, and provided in a substantially horizontal orientation. When referring to the arms 106 and posts 104, it is noted that the orientation of each need only have a substantial component in the noted direction, sufficient to perform the task of supporting the vehicle.

Each of the arms 106 is attached to one of the posts at a first location 108 thereon. It will be appreciated that some embodiments of the system 100 may also include hydraulic or mechanical means 110 to move the arms 106 in a vertical direction (as generally denoted by arrow A in FIG. 1), either up or down, so as to raise or lower the vehicle, if needed.

Each of the arms 106 has an upper surface 112 configured to receive and retain thereon the vehicle. While shown in FIG. 1 in one manner, the upper surface 112 may be configured for engagement at or with a particular site or part on the undercarriage of the vehicle, or its tires.

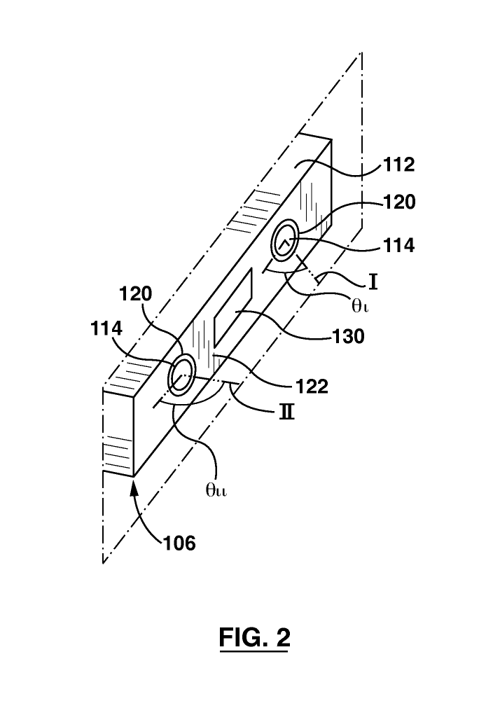

A plurality of lighting units 114 are provided. Each lighting unit 114 is adapted to provide light at an intensity and is configured to illuminate an underside area of the vehicle (not shown) when the vehicle is operatively positioned. The lighting units 114 may be provided on any or all of the arms 106, posts 104 and a base 116 of the hoist apparatus 102. Further, the system 100 may also include a floor 118, on which additional lighting units 114 are provided. The positioning of lighting units 114 in any embodiment may vary depending on the nature of the hoist type employed, as well as the type of vehicle to typically be repaired or inspected. Angles of different lighting units 114 may differ (e.g., as shown in FIG. 2 by arrows I and II), based on the area under the vehicle each aims to illuminate. Further, the intensity of each lighting unit 114 may vary depending on, for example, the area it is to illuminate, its proximity to such area. In addition, lighting units 114 may be provided with or without lenses. The number of lighting units 114 employed in a given embodiment may vary, as a function of the area to illuminate, intensities of the units 114 used, angles of lighting, and the like. In some embodiments, configurations with a single lighting unit per hoist arm 106 may be provided.

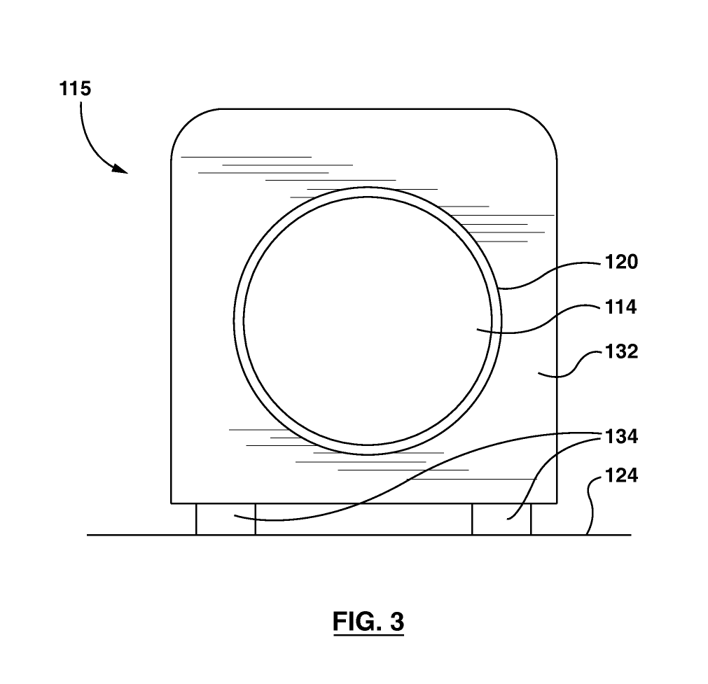

As best shown in FIG. 2, each lighting unit is provided in an attachment port 120, and disposed therein at an angle from one of the a plurality of surfaces 122, 124, 126 of the apparatus 102. Further, the lighting units 114 are provided integral to and substantially flush with the surface 122, 124, 126 of each of the arms 106. The surfaces may include side surfaces 124, 126 and an inner surface 122. As shown in FIG. 3, lighting units 114 may be provided in the form of lighting assemblies 115 that are attachable to the surfaces by way of, for example, magnets 134. The assembly 115 includes a housing 132 in which the attachment port 120 is provided. The manner of attachment of the assembly 115 to the hoist/lift may be magnetic, as described above, but may alternatively be by way of other means, including means allowing for rotating or telescoping movement of the housing 132 relative to the lift, and/or for manipulation of the direction of the lighting unit 114.

The angle of disposition may vary depending on the selections of a user (not shown but example location described herein as being position atop area U shown in FIG. 1). A control unit 128 is provided for setting and/or responsively altering one or more of the angle and intensity of the lighting units 114. As described above, these settings or alterations may be based on one or more of direct input from a user, monitored data, and one or more parameters pre-selected from a set of parameters. Direct input may include, for example, the user wanting to illuminate a particular quadrant of the underside of the vehicle, and from a particular direction, knowing that s/he will be standing in a certain area to work. Further, the user may preselect a lighting arrangement based on the details of the vehicle to be worked on, the nature of the work to be conducted. This process may include prompting the user, or the user indicating when a phase of the process (if the maintenance or inspection process undertaken is multi-phase, requiring differing lighting arrangements). A plurality of repair routines may be programmed into a processor of the control unit 128. Each routine includes details of a vehicle the user will be servicing, and the nature of the servicing, and sets ones of the intensities and angles for the lighting units 114 accordingly. For example, if a repair is to be conducted on an area underneath the vehicle requiring the user to stand (not kneel) atop the area U in FIG. 1, then lights on the inner surface 122 of the arm 106 closest to area U would not be illuminated at those would be shining into the face of the user. In contrast lighting units 114 on others of the arms 106 and posts 108, would be shining and directed at the area of interest. The variety of procedures that may be undertaken in respect of a vehicle is wide, and all cannot be reasonably detailed herein; however, the above is one example of the function of an embodiment of the disclosed system 100.

The system 100 may also adjust angles and intensities (some of which may, as described above, be zero, as needed) in response to monitored data. For the purposes of collecting monitored data, the system 100 may further include one or more motion detection devices 130, in data communication with the control unit 128. These devices will report on the position of the user, as well as his/her orientation (e.g., noting a kneeling position so as to engage lighting units 114 that would have been blocked by a standing user). The position of the vehicle (e.g., in the relative directions denoted by arrows A, C and D in FIG. 1 may also impact the lighting arrangement to be employed. Further, the control unit 128 may include or consist of a handheld computing device (not shown) carried by the user (e.g., in the form of a smart phone), which may also report positional data to inform the alteration or attenuation of the intensities and angles of the lighting units 114.

The hoist apparatus 102 may, in some embodiments, include a floor 118, with a base 134 of each post 104 being affixed to the floor 118. As shown in FIG. 1, lighting units may be provide on the floor 118.

While shown in round and stripped arrangements, it will be appreciated that the lighting units 114 may be provided in alternate arrangements, depending on the geometry of the hoist involved (e.g., arms, posts, floor). Further, the lighting units 114 may preferably by LED-based light sources (for reasons of energy efficiency and low heat levels); however, other types of light sources may be employed, as well.

The intensity is comprised of a candela value for each lighting unit 114, as well as a focus area on which the particular lighting unit may be trained. Both variable may be adjustable, to best illuminate the area of interest under the vehicle.

The lighting units 114 may be provided in the attachment ports 120 in a removable and retractable manner, so as to allow selection and use thereof by the user for close inspection of a particular area. The lighting units 114 may also be detachable from the ports 120. In some embodiments, provided on the hoist apparatus 102, each adapted to receive the lighting units, and the lighting units 114 are configured for engagement with and disengagement from the attachment ports 120.

Systems disclosed herein may be provided as new products built into a hoist apparatus or may be provided on a refitting basis. For example, in some scenarios it may be impractical or financially undesirable to replace the entire apparatus rather than refit an existing one.

Particular one(s) of the light sources to be on at a given time and the intensity and/or direction of each may be set as a function of a pre-programmed set of parameters based on, for example, the type of vehicle, the size of the vehicle, its orientation on the hoist, the nature of the work being performed, the size and number of the person(s) completing the work. In addition, the intensity of the light from each source and the coverage area of each source may also be adjustable.

If integral to the arms or other components of the hoist, the light sources may be positioned in a moveable arrangement (e.g., in slots, in the ports in a rotatable or telescoping manner) as well as focusable manner so as to optimize lighting of those areas on the vehicle most commonly worked on and requiring the most direct lighting. The lighting units 114 may be powered by batteries, but may be powered directly from electrical power sources included in or wired through the hoist apparatus 102 (for example, when integral to such apparatuses). The system 100 may be provided with the control unit 128 as a bench mounted control devices; however, systems 100 may, in some embodiments, be operated from a handheld remote control or hoist-mounted controls (which would be positioned so as to minimize any safety concerns). An on/off switch 136 for the system 100 may be provided on the control unit 128 (see FIG. 1).

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It will be understood that the principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

Additionally, the section headings herein are provided as organizational cues. These headings shall not limit or characterize the invention(s) set out in any claims that may issue from this disclosure. Specifically and by way of example, although the headings refer to a “Field of Invention,” such claims should not be limited by the language under this heading to describe the so-called technical field. Further, a description of technology in the “Background of the Invention” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps.

All of the systems and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims.

1. A lighting system comprising:
(a) a hoist apparatus comprising:
i. one or more posts provided in a substantially vertical orientation;
ii. two or more arms provided in a substantially horizontal orientation, each attached to one of the posts at a first position thereon, and each having an upper surface configured to receive a vehicle;
(b) one or more lighting units each attached to the hoist apparatus; wherein each of the lighting units is adapted to provide light at an intensity and is configured to illuminate an underside area of the vehicle when the vehicle is operatively positioned;
(c) wherein each of the lighting units is adjustably disposed at an angle from the apparatus; and,
(d) a control unit for setting and/or responsively altering one or more of the angle and intensity of one or more of the lighting units, based on one or more of direct input from a user, monitored data, and one or more parameters pre-selected from a set of parameters.

2. A lighting system according to claim 1, wherein the lighting units are provided integral to and substantially flush with a surface of each of the arms.

3. A lighting system according to claim 1, wherein the direct input comprises selection of a repair routine comprising details of a vehicle the user will be servicing, and the nature of the servicing.

4. A lighting system according to claim 1, wherein the set of parameters comprises a plurality of lighting arrangements, wherein in each of the arrangements one or more areas of the underside of a vehicle would be illuminated and the intensity of each of the lighting units would be set accordingly.

5. A lighting system according to claim 1, wherein the monitored data comprises one or more of:
a. a position of the user;
b. an orientation of the user; and,
c. a position of the vehicle.

6. A lighting system according to claim 1, wherein the hoist apparatus further comprises a floor, wherein post further comprises a base affixed to the floor, and wherein at least one of the lighting units is attached to the floor.

7. A lighting system according to claim 1, wherein at least one of the lighting units comprises a light emitting diode based light source.

8. A lighting system according to claim 1, wherein the intensity comprises a measurement in candelas.

9. A lighting system according to claim 8, wherein the intensity further comprises a focus area.

10. A lighting system according to claim 1, further comprising a plurality of attachment ports provided on the hoist apparatus, each adapted to receive the lighting units, wherein the lighting units are configured for engagement with and disengagement from the attachment ports.
